(19) United States
(12) Patent Application Publication
(10) Pub. No.: US 2024/0165905 A1
(43) Pub. Date: May 23, 2024

(54) PROCESS FOR THE REPURPOSING OF CORRUGATED MATERIAL TO CREATE A HARD CARDBOARD MATERIAL

(71) Applicant: SA29StudioDesigns LLC, Denver, CO (US)

(72) Inventor: Sean Andersen, Denver, CO (US)

(21) Appl. No.: 18/516,613

(22) Filed: Nov. 21, 2023

Related U.S. Application Data
(60) Provisional application No. 63/427,137, filed on Nov. 22, 2022.

(51) Int. Cl. B31B 50/74; B09B 3/35

(52) U.S. Cl. CPC B31B 50/741; B09B 3/35; B31B 50/742

(57) ABSTRACT

A method of creating a hard cardboard material. The hard cardboard material can be made by shredding a corrugated material to a desired size to create a shredded corrugated material. The shredded corrugated material can be mixed with an adhesive material to create a corrugated mixture of the shredded corrugated material and the adhesive material. The corrugated mixture can be compressed to create a compressed mixture of a desired size. The compressed mixture can then be dried for a desired amount of time to create the hard cardboard material.

### CROSS-REFERENCE TO RELATED APPLICATIONS

The present application is a conversion of U.S. Provisional application having U.S. Ser. No. 63/427,137, filed Nov. 22, 2022, which claims the benefit under 35 U.S.C. 119(e). The disclosures of which is hereby expressly incorporated herein by reference.

### STATEMENT REGARDING FEDERALLY SPONSORED RESEARCH OR DEVELOPMENT

Not applicable.

### BACKGROUND OF THE DISCLOSURE

### 1. Field of the Invention

The present disclosure relates to a process for repurposing a corrugated material, such as used cardboard boxes, to create a hard cardboard material that can have numerous uses.

### 2. Description of the Related Art

Corrugated material is used for numerous purposes across various industries, such as for providing cardboard boxes for packaging and shipping goods. Therefore, large amounts of used cardboard boxes exist. Most of the time these used cardboard boxes are recycled to create new cardboard boxes or corrugated material for other uses. In some instances, the used cardboard boxes are destroyed.

Accordingly, there is a need for alternative uses for used corrugated material, such as used cardboard boxes.

### SUMMARY OF THE DISCLOSURE

The present disclosure is directed to a method of creating a hard cardboard material. The hard cardboard material can be made by shredding a corrugated material to a desired size to create a shredded corrugated material. The shredded corrugated material can be mixed with an adhesive material to create a corrugated mixture of the shredded corrugated material and the adhesive material. The corrugated mixture can be compressed to create a compressed mixture of a desired size. The compressed mixture can then be dried for a desired amount of time to create the hard cardboard material.

### BRIEF DESCRIPTION OF THE DRAWINGS

FIGS. 1A and 1B are perspective views of a hard cardboard material constructed in accordance with the present disclosure.

FIG. 2 is a perspective view of shredded cardboard used in accordance with the present disclosure.

FIG. 3 is a perspective view of the shredded cardboard mixed with an adhesive material in accordance with the present disclosure.

FIG. 4 is a perspective view of a mixture of the shredded cardboard and adhesive material in a compressive container in accordance with the present disclosure.

FIG. 5 is a perspective view of the mixture of the shredded cardboard and adhesive material being compressed in the compressive container by a press constructed in accordance with the present disclosure.

FIG. 6 is a perspective view of a drying container used in accordance with the present disclosure.

FIG. 7 is a side-elevation view of the drying container shown in FIG. 6 and used in accordance with the present disclosure.

### DETAILED DESCRIPTION OF THE DISCLOSURE

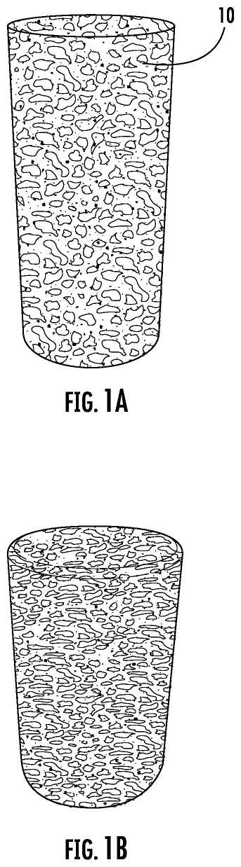

The present disclosure relates to a process for repurposing a corrugated material, such as used cardboard boxes, to create a hard cardboard material 10, such as that shown in FIG. 1, that can have numerous uses. The hard cardboard material 10 created by the repurposing process is much denser and stronger than typical cardboard material. The process includes gathering corrugated material that is suitable for the process. Some corrugated material may not be suitable for the repurposing process disclosed herein because the corrugated material might have some type of coating or paint that would prevent it from being suitable for the repurposing process. It should be understood and appreciated that not all paints and coatings used on corrugated material makes the corrugated material unsuitable for the repurposing process disclosed herein.

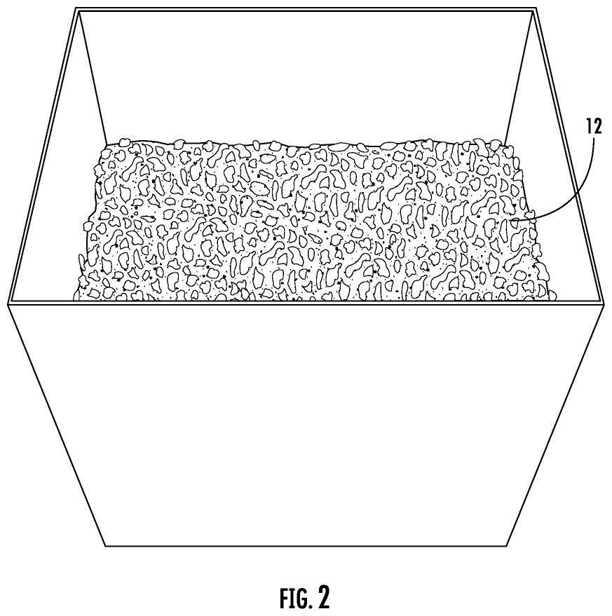

Once enough suitable corrugated material has been collected, the corrugated material can be shredded into a desirable size to create a shredded corrugated material 12 as shown in FIG. 2. Shredding the corrugated material down to certain sizes permits for a hard cardboard material 10 with stronger bonds. The size of the pieces of the shredded corrugated material 12 can be any size such that the desired strength and density of the hard cardboard material 10 is achieved. In one embodiment, the pieces/strips of the shredded corrugated material 12 can be about 3/32″ to about 7/32″ wide by about 1″ to about 1¾″ long. In another embodiment, the pieces/strips of the shredded corrugated material 12 can be about 4/32″ to about 6/32″ wide by about 1¼″ to about 1½″ long.

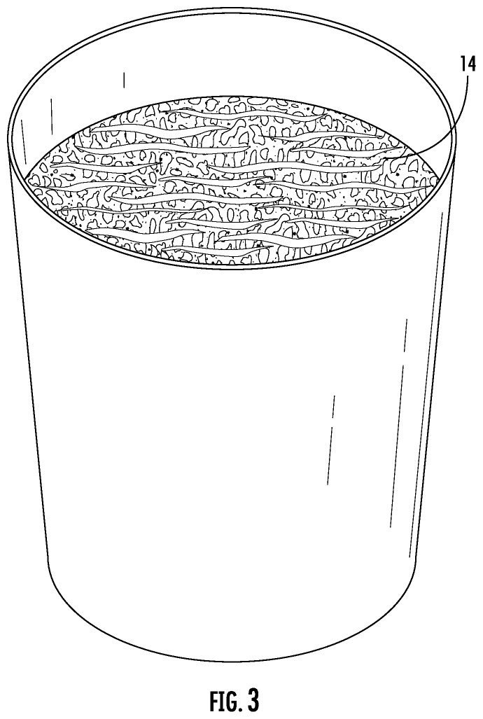

Referring now to FIG. 3, the shredded corrugated material 12 can be combined with an adhesive material to create a cardboard mixture 14, which becomes the hard cardboard material 10 after additional processing. The adhesive material can be any glue-type material capable of giving the hard cardboard material 10 its desired properties. One example of an adhesive material is TiteBond® III ultimate wood glue. The amount of shredded corrugated material 12 and adhesive material used to create the hard cardboard material 10 depends on the volume of the resulting hard cardboard material 10. The amount of shredded corrugated material 12 used to make a certain amount of the hard cardboard material 10 can be roughly 8-12 times the volume (when the shredded corrugated material 12 has not been subject to any compression or other type of manipulation) of the desired volume of the hard cardboard material 10. In another embodiment, the amount of shredded corrugated material 12 used to make a certain amount of the hard cardboard material 10 can be roughly 9-11 times the volume of the desired volume of the hard cardboard material 10. In yet another embodiment, the amount of shredded corrugated material 12 used to make a certain amount of the hard cardboard material 10 can be roughly 10 times the volume of the desired volume of the hard cardboard material 10.

Similarly, the amount of adhesive material used to make a certain amount of the hard cardboard material 10 can be roughly 0.125 to about 0.5 times the volume of the desired volume of the hard cardboard material 10. In another embodiment, the amount of adhesive material used to make a certain amount of the hard cardboard material 10 can be roughly 0.2 to about 0.35 times the volume of the desired volume of the hard cardboard material 10. In yet another embodiment, the amount of adhesive material used to make a certain amount of the hard cardboard material 10 can be roughly 0.25 times the volume of the desired volume of the hard cardboard material 10. After the desired amounts of shredded corrugated material 12 and adhesive material have been decided, the shredded corrugated material 12 and adhesive material are mixed together.

In another embodiment of the present disclosure, the adhesive material can be made from a powdered adhesive, such as Cascamite®, mixed with water. The amount (volume) of water used to create the adhesive material is about ¼ to ½ of the volume of the hard cardboard material 10. In one embodiment, amount (volume) of water used to create the adhesive material is about ⅜ of the volume of the hard cardboard material 10. The volume of water used has a given weight. Once the desired amount of water is calculated, the amount of powdered adhesive is determined to be mixed with the water to generate the adhesive material. The amount, or weight, of powdered adhesive can be about 1.75 times to about 2.25 times the weight of the water desired to be used.

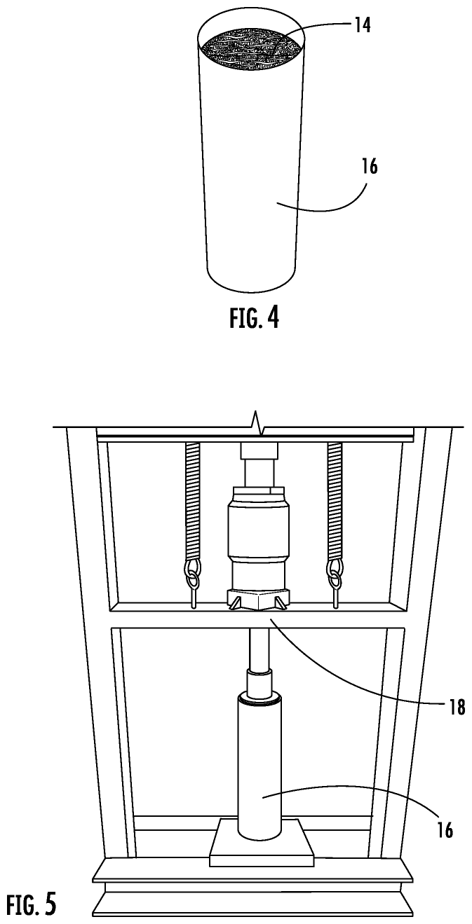

The mixture of shredded corrugated material 12 and adhesive material can then be placed into a shaped container 16, as shown in FIG. 4, with the desired shape and size to give the resulting hard cardboard material 10 a desired shape. The shaped container 16 can be cylindrical, cube shaped, cuboid shaped, and the like. The shaped container 16 should be large enough that the mixture of shredded corrugated material 12 and adhesive material can be placed therein without the need to compress the mixture at all. The shaped container 16 can also be designed so that none of the mixture can escape the sides or bottom of the shaped container 16. The mixture of the shredded corrugated material 12 and adhesive material can then compressed in the shaped container 16. A plate (not shown) can be placed over the top of the mixture of the shredded corrugated material 12 and adhesive material prior to compression of the mixture 14. As shown in FIG. 5, the shredded corrugated material 12 and adhesive material can then be subjected to a compression apparatus 18. The compression apparatus 18 can be any apparatus known in the art that can be used for compressing the mixture 14, such as a hydraulic press, pneumatic press, mechanically driven compression device, etc. Depending upon the desired density of the hard cardboard material 10, the mixture 14 of the shredded corrugated material 12 and adhesive material can be compressed to a certain percentage of the volume of the mixed and uncompressed mixture 14 of the shredded corrugated material 12 and adhesive material. In one embodiment, the mixed and uncompressed mixture 14 of the shredded corrugated material 12 and adhesive material can be compressed down to a volume that is less than about 20% of the volume of the mixed and uncompressed mixture 14 of the shredded corrugated material 12 and adhesive material. In another embodiment, the mixed and uncompressed mixture 14 of the shredded corrugated material 12 and adhesive material can be compressed down to a volume that is less than about 15% of the volume of the mixed and uncompressed mixture 14 of the shredded corrugated material 12 and adhesive material. In a further embodiment, the mixed and uncompressed mixture 14 of the shredded corrugated material 12 and adhesive material can be compressed down to a volume that is less than about 10% of the volume of the mixed and uncompressed mixture 14 of the shredded corrugated material 12 and adhesive material, or more than about 10 times less than the volume of the mixed and uncompressed mixture 14 of the shredded corrugated material 12 and adhesive material. In yet another embodiment, the mixed and uncompressed mixture 14 of the shredded corrugated material 12 and adhesive material can be compressed down to a volume that is less than about 5% of the volume of the mixed and uncompressed mixture 14 of the shredded corrugated material 12 and adhesive material.

After the mixture 14 of the shredded corrugated material 12 and adhesive material is compressed down to the desired density (or volume), a clamp (not shown) can be applied to the compressed mixture 14 in the container for a certain amount of time to let the mixture equalize. The clamp could be any device capable of maintaining compression of the mixture 14 of the shredded corrugated material 12 and adhesive material down to the desired density (or volume). The clamp is used to maintain the shape of the compressed mixture of the shredded corrugated material 12. During equalization, the adhesive material is allowed to achieve maximum penetration into the shredded corrugated material 12. The compressed mixture can be allowed to equalize for any amount of time such that the desired qualities of the hard cardboard material 10 are achieved. In one embodiment, the compressed mixture can be allowed to equalize for at least 12 hours. In another embodiment, the compressed mixture can be allowed to equalize for at least 18 hours. In yet another embodiment, the compressed mixture can be allowed to equalize for at least 24 hours.

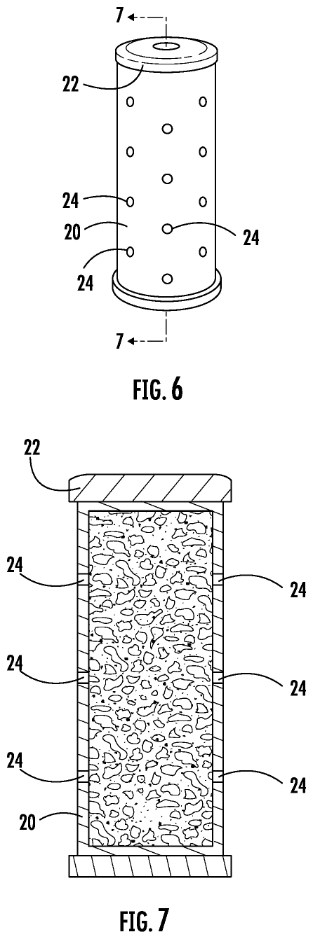

Once the desired amount of time has lapsed for equalization of the compressed mixture, the compressed mixture is removed from the shaped container 16 where the compression, clamping and equalization occurred. As shown in FIGS. 6 and 7, after removal of the compressed mixture from the shaped container 16, the compressed mixture is placed into a drying container 20 that is similarly shaped as the shaped container 16 where the compression clamping and equalization occurred. The similar shape for the drying container 20 is so that the compressed mixture maintains the same shape. The drying container 20 will have a top 22 that takes the place of the compression apparatus 18 used to compress the mixture 14 and the clamping device. The drying container 20 can have numerous openings 24 therein to permit the compressed mixture 14 to fully dry. The openings 24 can be sized such that air is permitted to get to the compressed mixture 14, but not so big that the compressed mixture 14 is permitted to flow out of the openings 24. The compressed mixture 14 can be permitted to stay in the drying container 20 for any amount of time such that the compressed mixture 14 has dried a sufficient amount. In one embodiment, the compressed mixture 14 can be permitted to stay in the drying container 20 for at least 24 hours. In another embodiment, the compressed mixture 14 can be permitted to stay in the drying container 20 for at least two days. In yet another embodiment, the compressed mixture 14 can be permitted to stay in the drying container 20 for at least three days.

The compressed mixture 14 can then be taken out of the drying container 20 to dry further. The compressed mixture 14 can be set out to dry for any amount of time such that the weight of the compressed mixture 14 does not change any further. Once the weight of the compressed mixture 14 no longer changes from one day to the next, the hard cardboard material 10 has been created. The hard cardboard material 10 can be cut into desired sizes, sanded, dyed, or stained in a similar manner to wood. The hard cardboard material 10 created by this process will have unique features such as a certain amount (weight, volume, etc.) of shredded corrugated material 12 per unit of volume or weight of the hard cardboard material 10. Similarly, the hard cardboard material 10 created by this process will have a certain amount (weight, volume, etc.) of adhesive material per unit of volume or weight of the hard cardboard material 10.

From the above description, it is clear that the present disclosure is well-adapted to carry out the objectives and to attain the advantages mentioned herein as well as those inherent in the disclosure. While presently preferred embodiments have been described herein, it will be understood that numerous changes may be made which will readily suggest themselves to those skilled in the art and which are accomplished within the spirit of the disclosure and claims.

What is claimed is:

1. A method of creating a hard cardboard material, the process comprising:
shredding a corrugated material to a desired size to create a shredded corrugated material;
mixing the shredded corrugated material with an adhesive material to create a corrugated mixture of the shredded corrugated material and the adhesive material;
compressing the mixture of the shredded corrugated material and the adhesive material to create a compressed mixture of a desired size; and
drying the compressed mixture for a desired amount of time to create the hard cardboard material.

2. The method of claim 1 wherein the desired size of the shredded corrugated material is about 3/32 inch to about 7/32 inch wide by about 1″ inch to about 1.75 inches long.

3. The method of claim 1 wherein the desired size of the shredded corrugated material is about ⅛ inch to about 3/16 inch wide by about 1.25″ inches to about 1.5 inches long.

4. The method of claim 1 wherein the shredded corrugated material in the corrugated mixture is present in an amount by volume that is about 8-12 times more than the volume of the hard cardboard material created.

5. The method of claim 1 wherein the shredded corrugated material in the corrugated mixture is present in an amount by volume that is about 9-11 times more than the volume of the hard cardboard material created.

6. The method of claim 1 wherein the adhesive material in the corrugated mixture is present in an amount by volume that is about 0.2 to about 0.3 times the volume of the hard cardboard material created.

7. The method of claim 1 wherein the adhesive material in the corrugated mixture is present in an amount by volume that is about 0.125 to about 0.5 times the volume of the hard cardboard material created.

8. The method of claim 1 wherein the adhesive material is made from a powdered adhesive and water mixture.

9. The method of claim 8 wherein the water is present in the powdered adhesive and water mixture in an amount by volume of about ¼ to about ½ times the volume of the hard cardboard material created.

10. The method of claim 9 wherein the powdered adhesive is present in the powdered adhesive and water mixture in an amount by weight that is about 1.75 to about 2.25 times the weight of the water in the powdered adhesive and water mixture.

11. The method of claim 1 wherein the corrugated mixture is compressed down into the compressed mixture to a volume that is less than about 20 percent of the volume of the corrugated mixture.

12. The method of claim 1 wherein the corrugated mixture is compressed down into the compressed mixture to a volume that is less than about 10 percent of the volume of the corrugated mixture.

13. The method of claim 1 wherein the corrugated mixture is compressed down into the compressed mixture to a volume that is less than about 5 percent of the volume of the corrugated mixture.

14. The method of claim 1 further comprising clamping the compressed mixture in a container to permit the compressed mixture to equalize.

15. The method of claim 14 wherein the compressed mixture is clamped for at least 12 hours.

16. The method of claim 14 further comprising transferring the compressed mixture to a drying container to permit the compressed mixture to dry for a predetermined amount of time, the drying container is sized and shaped to maintain the size and shape of the compressed mixture while drying.

17. The method of claim 16 wherein the drying container includes holes therein to assist in the drying of the compressed material.

18. The method of claim 17 wherein the compressed material can stay in the drying container for more than 24 hours.

19. The method of claim 18 further comprising removing the compressed material from the drying container to undergo further drying.

20. The method of claim 19 wherein the compressed material is permitted to dry outside of the drying container until the weight of the compressed material remains constant after a given period of time.
